(19) United States
(12) Patent Application Publication
(10) Pub. No.: US 2024/0220989 A1
(43) Pub. Date: Jul. 4, 2024

(54) System for Dynamic Anomaly Detection

(71) Applicant: Bank of America Corporation, Charlotte, NC (US)

(72) Inventor: James D. Goodwin, Holt, MO (US)

(21) Appl. No.: 18/149,231

(22) Filed: Jan. 3, 2023

(51) Int. Cl. G06Q 20/40; G06Q 20/18

(52) U.S. Cl. CPC G06Q 20/4016; G06Q 20/18

(57) ABSTRACT

Arrangements for providing dynamic anomaly detection functions are provided. In some aspects, historical data associated with a plurality of transactions at a plurality of self-service kiosks may be received. A self-service kiosk simulation may be executed to capture simulated transaction data. The historical data and simulated transaction data may be used to generate a body of successful customer flows. After generating the body of successful customer flows, first transaction data may be received from a self-service kiosk. The first transaction data may be compared to the body of successful customer flows. If a match does not exist, an anomaly may be detected and the first transaction data may be flagged for further analysis. One or more mitigation actions may be identified in response to detecting the anomaly and a command to automatically execute the one or more mitigation actions may be generated and transmitted to the self-service kiosk for execution.

### BACKGROUND

Aspects of the disclosure relate to electrical computers, systems, and devices for dynamically detecting anomalies at, for instance, self-service kiosks.

Identifying anomalies occurring during transaction processing at self-service kiosks can be difficult. Conventional systems may not capture data identifying issues with the self-service kiosk, particularly data related to software issues. Accordingly, enterprise organizations operating self-service kiosks often are unaware of issues with a self-service kiosk until customer complaints are received. This can lead to unnecessary downtime of the self-service kiosk and prolonged outages or repair times. Accordingly, it would be advantageous to identify, as transactions are processed, whether a transaction was successfully completed in order to quickly identify and mitigate any issues.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with dynamically detecting anomalies at self-service kiosks.

In some aspects, historical data associated with a plurality of transactions at a plurality of self-service kiosks may be received. Further, a self-service kiosk simulation may be executed by one or more computing systems to capture simulated transaction data. The historical data and simulated transaction data may be used to generate a body of successful customer flows.

After generating the body of successful customer flows, first transaction data may be received from a self-service kiosk. The first transaction data may be compared to the body of successful customer flows. If a match exists, an anomaly is not present in the first transaction data and the first transaction data may be discarded.

If a match does not exist, an anomaly may be detected and the first transaction data may be flagged. Flagging the first transaction data may cause the first transaction data to be further analyzed. In some examples, one or more mitigation actions may be identified in response to detecting the anomaly. An instruction or command to automatically execute the one or more mitigation actions may be generated and transmitted to the self-service kiosk for execution.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing anomaly detection functions in accordance with one or more aspects described herein;

FIGS. 2A-2E depict an illustrative event sequence for implementing anomaly detection functions in accordance with one or more aspects described herein;

FIG. 3 illustrates an illustrative method for implementing anomaly detection functions according to one or more aspects described herein;

FIGS. 4 and 5 illustrate example user interfaces that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, identifying and tracking issues with self-service kiosks, such as automated teller machines (ATMs) can be difficult. Often, conventional systems merely track whether a transaction was completed or not completed or whether there was a hardware malfunction (e.g., jam, or the like). This lack of data can make identifying issues with a self-service kiosk difficult or impossible until customer begin to complain.

Accordingly, aspects described herein enable dynamic anomaly detection at a plurality of self-service kiosks. In some examples, historical data and/or self-service kiosk simulation data may be captured and used to generate or build a body of successful customer flows (e.g., transactions processed as expected, within a predetermined amount of time, with an expected number of steps, with successful completion, and the like). As transactions occur at the plurality of self-service kiosks, user transaction data may be captured and compared to the body of successful customer flows. If the user transaction data matches at least one customer flow of the successful body of flows, no anomaly may be detected and the data may be discarded.

If the user transaction data does not match at least one successful customer flow, an anomaly may be detected and one or more mitigation actions may be identified. Based on the identified mitigation action, an instruction or command to execute the identified mitigation action may be generated and transmitted to the impacted self-service kiosk. Transmitting the instruction or command to the impacted self-service kiosk may cause the self-service kiosk to automatically execute the mitigation action.

These and various other arrangements will be discussed more fully below.

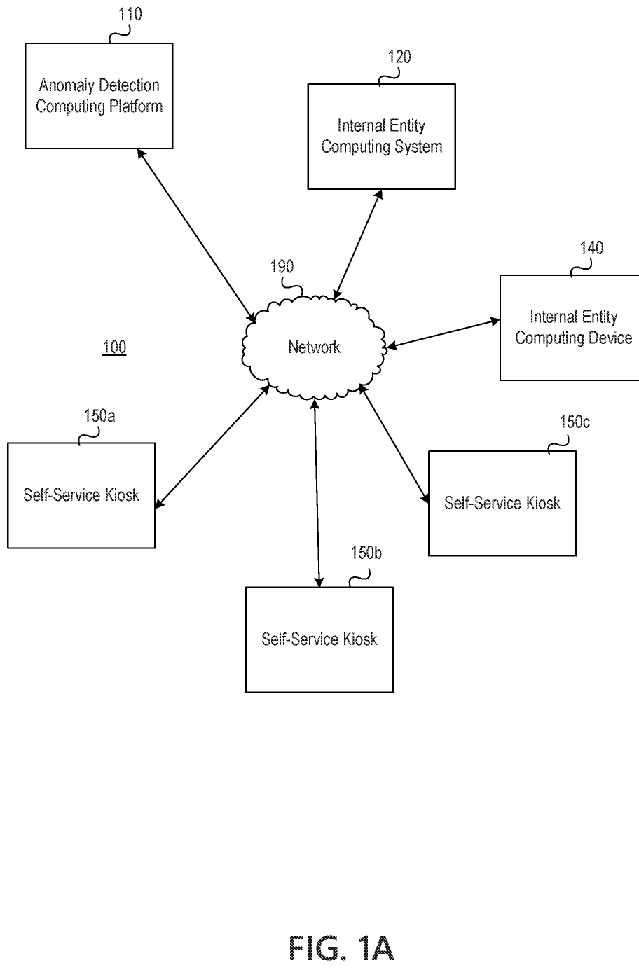

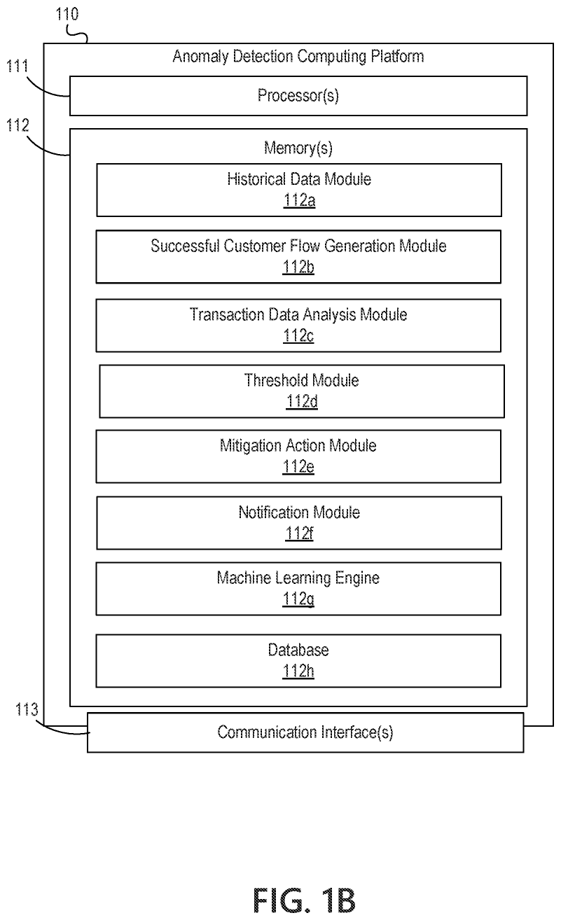

Aspects described herein may be implemented using one or more computing devices operating in a computing environment. For instance, FIGS. 1A-1B depict an illustrative computing environment for implementing dynamic anomaly detection in accordance with one or more aspects described herein. Referring to FIG. 1A, computing environment 100 may include one or more computing devices and/or other computing systems. For example, computing environment 100 may include anomaly detection computing platform 110, internal entity computing system 120, internal entity computing device 140, self-service kiosk 150a, self-service kiosk 150b, and self-service kiosk 150c. Although one internal entity computing system 120, one internal entity computing device 140, and three self-service kiosks 150a-150c are shown, any number of systems or devices may be used without departing from the invention.

Anomaly detection computing platform 110 may be configured to perform intelligent, dynamic, and efficient anomaly detection functions for a plurality of self-service kiosks, such as self-service kiosks 150a-150c. For instance, anomaly detection computing platform 110 may receive, from a self-service kiosk simulation that may be run on, for instance, internal entity computing system 120, internal entity computing device 140, or the like, a plurality of successful customer flows. In some examples, a customer flow may include one or more processes, interfaces, displays, user inputs, or the like, that occur between initiation of a transaction at a self-service kiosk and completion of the transaction at the self-service kiosk. Anomaly detection computing platform 110 may build, based on the received successful customer flows, a body of successful customer flows against which all customer flows occurring at the plurality of self-service kiosks in an in-use environment may be compared.

Accordingly, as users conduct transactions at one or more self-service kiosks 150a-150c, transaction data including user input, interfaces displayed, keys activated, funds dispensed, number of steps, whether the transaction was successfully completed, whether the transaction was completed within an expected amount of time, and the like, may be received by the anomaly detection computing platform 110 to determine whether the transaction data matches one or more successful customer flows. If so, the transaction data may be discarded (e.g., deleted). If not, the transaction data may be flagged, logged, and transmitted for further analysis.

Internal entity computing system 120 may be or include one or more computing devices (e.g., servers, server blades, or the like) and/or one or more computing components (e.g., memory, processor, and the like) and may be associated with or operated by an enterprise organization implementing the anomaly detection computing platform 110. The internal entity computing system 120 may execute self-service kiosk simulations to identify successful customer flows that may be used to detect anomalies in real-time or in-use customer transaction data.

Internal entity computing device 140 may be or include one or more computing devices (e.g., laptops, desktops, mobile devices, tablets, and the like) and may be used to control, modify, adjust, or the like, aspects of the internal entity computing system 120, anomaly detection computing platform 110, or the like. For instance, internal entity computing device 140 may be used by a system administrator or other associate to control self-service kiosk simulations, receive identified anomalies, analyze identified anomalies, and the like.

Self-service kiosk 150a-150c may include self-service kiosks, such as automated teller machines (ATMs), automated teller assistants (ATAs) and the like. The self-service kiosks 150a-150c may be associated with the enterprise organization and in communication with one or more systems of the enterprise organization (e.g., account updating systems, and the like). Self-service kiosks 150a-150c may be used by various customers of the enterprise organization, non-customer users, and the like, to conduct various types of transactions (e.g., deposits, cash withdrawals, balance transfers, balance inquiries, and the like).

As mentioned above, computing environment 100 also may include one or more networks, which may interconnect one or more of anomaly detection computing platform 110, internal entity computing system 120, internal entity computing device 140, self-service kiosk 150a, self-service kiosk 150b, and/or self-service kiosk 150c. For example, computing environment 100 may include network 190. In some examples, network 190 may include a private network associated with the enterprise organization. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may interconnect one or more computing devices associated with the organization. For example, anomaly detection computing platform 110, internal entity computing system 120, internal entity computing device 140, self-service kiosk 150a, self-service kiosk 150b, and/or self-service kiosk 150c may be associated with an enterprise organization (e.g., a financial institution), and network 190 may be associated with and/or operated by the organization, and may include one or more networks (e.g., LANs, WANs, virtual private networks (VPNs), or the like) that interconnect anomaly detection computing platform 110, internal entity computing system 120, internal entity computing device 140, self-service kiosk 150a, self-service kiosk 150b, and/or self-service kiosk 150c and one or more other computing devices and/or computer systems that are used by, operated by, and/or otherwise associated with the organization.

Referring to FIG. 1B, anomaly detection computing platform 110 may include one or more processors 111, memory 112, and communication interface 113. A data bus may interconnect processor(s) 111, memory 112, and communication interface 113. Communication interface 113 may be a network interface configured to support communication between anomaly detection computing platform 110 and one or more networks (e.g., network 190, network 195, or the like). Memory 112 may include one or more program modules having instructions that when executed by processor(s) 111 cause anomaly detection computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of anomaly detection computing platform 110 and/or by different computing devices that may form and/or otherwise make up anomaly detection computing platform 110.

For example, memory 112 may have, store and/or include historical data module 112a. Historical data module 112a may store instructions and/or data that may cause or enable the anomaly detection computing platform 110 to receive historical transaction data from a plurality of self-service kiosks, analyze the historical transaction data and, based on the analysis, identify successful customer flows within the historical data. This data may then be stored by successful customer flow generation module 112b, along with simulation data identifying successful customer flows.

Successful customer flow generation module 112b may store instructions and/or data that may cause or enable the anomaly detection computing platform 110 to receive results of simulation(s) of self-service kiosk transactions to identify successful customer flows. For instance, internal entity computing system 120 may execute a plurality of customer flow simulations for a self-service kiosk. The output may then be provided to the successful customer flow generation module 112b to identify successful customer flows and store the successful customer flows for use in analyzing user transaction data to identify anomalies.

Anomaly detection computing platform 110 may further have, store and/or include transaction data analysis module 112c. Transaction data analysis module 112c may store instructions and/or data that may cause or enable the anomaly detection computing platform 110 to receive transaction data from a plurality of self-service kiosks 150a-150c and compare the transaction data to the successful customer flow data stored in the successful customer flow generation module 112b to detect anomalies or customer flows that differ from the successful customer flows. In some examples, machine learning may be used to compare the transaction data to the successful customer flows to detect anomalies. Further, in some arrangements, each customer flow may include a plurality of data points. Comparing the transaction data to the successful customer flow may include comparing corresponding data points (or data categories) to data points in the successful customer flow and if one or more data points differ an anomaly may be identified and the transaction data flagged.

Anomaly detection computing platform 110 may further have, store and/or include threshold module 112d. Threshold module 112d may store instructions and/or data that may cause or enable the anomaly detection computing platform 110 to compare one or more types of anomalies (e.g., a particular type of anomaly occurring at a same self-service kiosk), a time of completion for each transaction, a number of anomalies at a particular self-service kiosk within a particular time period, or the like, to one or more thresholds stored by the threshold module 112d. In some examples, the threshold may be customizable based on enterprise organization, type of threshold, type of transaction, type of self-service kiosk, or the like. If a threshold is met or exceeded, one or more mitigating actions may be identified and/or executed.

Anomaly detection computing platform 110 may further have, store and/or include mitigation action module 112e. Mitigation action module 112e may store instructions and/or data that may cause or enable the anomaly detection computing platform 110 to identify, based on one or more thresholds being met or exceeded, one or more mitigation actions to execute. For instance, in some examples, if a particular threshold is exceeded, mitigation action module 112e may generate an instruction or command causing the impacted self-service kiosk to shut down (e.g., power off, indicate it is unavailable, or the like). In some examples, a mitigation action may include generating an instruction or command to modify functionality of the self-service kiosk impacted (e.g., not accept deposits, not allow withdrawals, or the like). The generated instruction or command may be transmitted to the self-service kiosk and executed, thereby modifying the operation or functionality of the impacted self-service kiosk. In some examples, the identified mitigation action may be automatically executed (e.g., without user input or interaction). Various other mitigation actions may be identified and/or executed without departing from the invention.

Anomaly detection computing platform 110 may further have, store and/or include notification module 112f. Notification module 112f may store instructions and/or data that may cause or enable one or more notifications to be generated, transmitted, displayed, or the like. For instance, upon detection of one or more anomalies at one or more self-service kiosks 150a-150c, a notification indicating that the one or more anomalies have been detected, a type of anomaly, additional data, and the like, may be generated and transmitted to, for instance, internal entity computing device 140. In some examples, transmitting the notification may cause the notification to be displayed on a display of internal entity computing device 140.

Anomaly detection computing platform 110 may further have, store and/or include machine learning engine 112g. Machine learning engine 112g may store instructions and/or data that may cause or enable the anomaly detection computing platform 110 to train, execute, validate and/or update a machine learning model that may be used to identify anomalies. In some examples, the machine learning model may be trained (e.g., using labeled historical data, labeled data from one or more simulations, or the like (e.g., data indicating successful vs. unsuccessful customer flows)) to identify patterns or sequences in transaction data that indicate a successful customer flow. The machine learning model may, in some arrangements, use as inputs user transaction data to output, based on execution of the model, and indication of whether an anomaly was detected (e.g., whether the transaction data matches one or more successful customer flows). In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models.

Anomaly detection computing platform 110 may further have, store and/or include a database 112h. Database 112h may store data associated with successful and unsuccessful customer flows, historical transaction data, mitigation actions identified and/or executed, and the like.

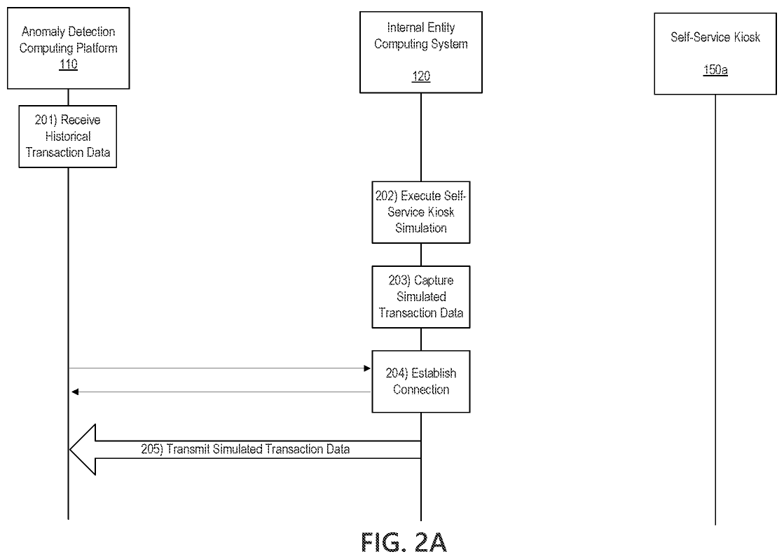

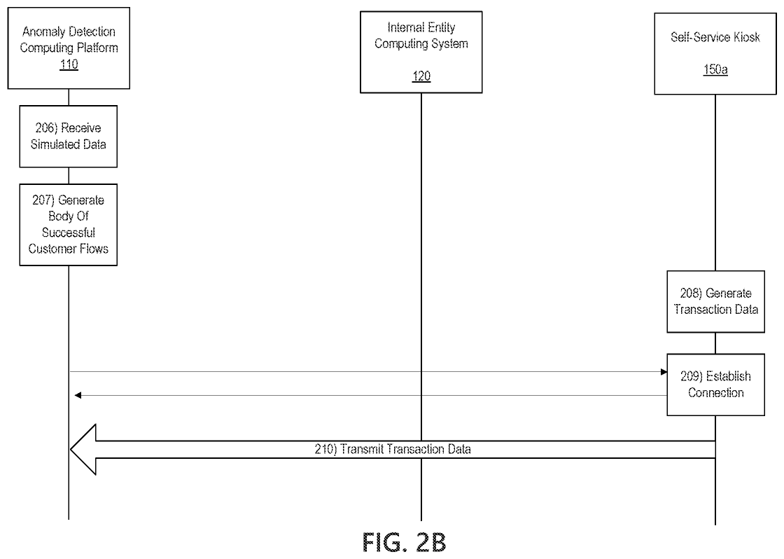

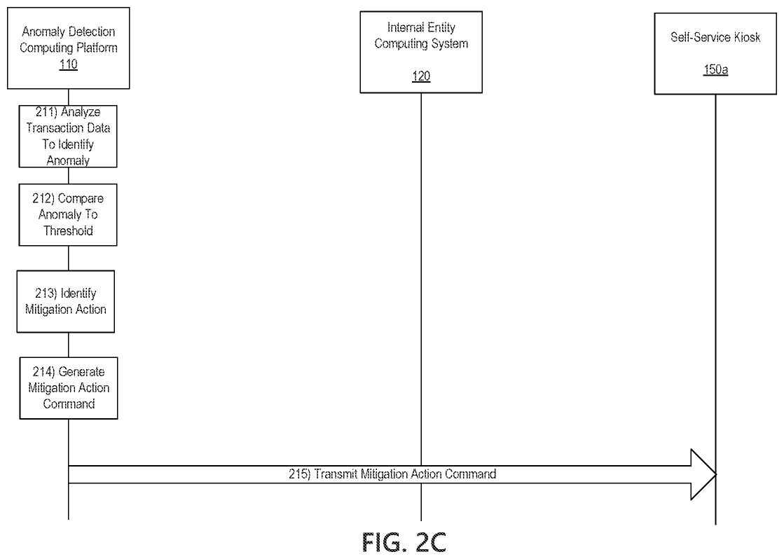

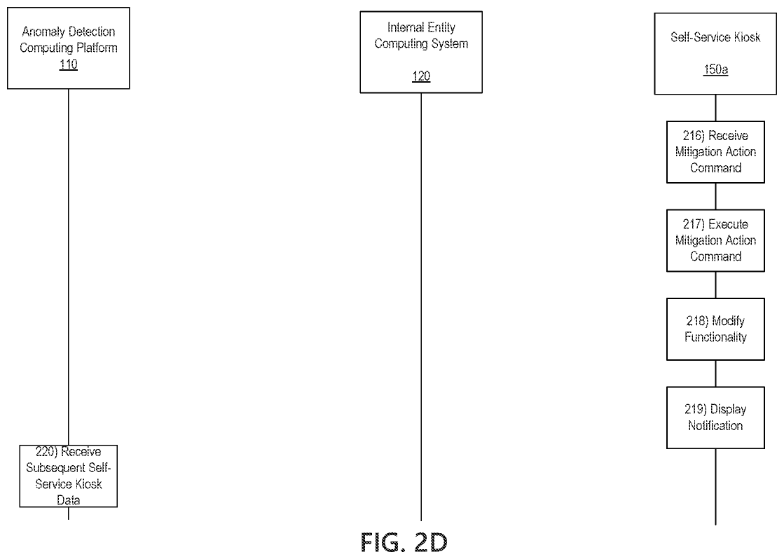

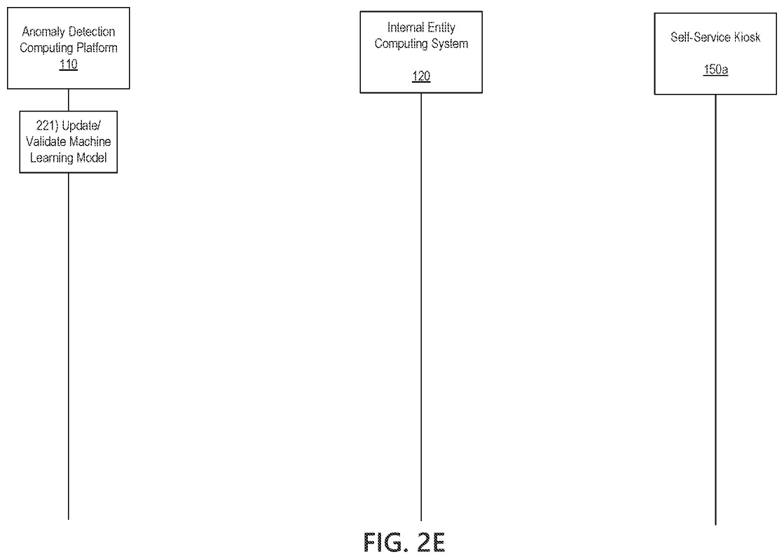

FIGS. 2A-2E depict one example illustrative event sequence for implementing anomaly detection functions in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, anomaly detection computing platform 110 may receive historical transaction data from a plurality of self-service kiosks 150a-150c. The historical transaction data may include data associated with a type of transaction, whether the transaction was successful, whether any mechanical issues occurred, a time to complete the transaction, user input received to process the transaction, a number of screens or interfaces displayed during the transaction, and the like.

At step 202, internal entity computing system 120 may execute a self-service kiosk simulation. For instance, internal entity computing system 120 may simulate a plurality of customer flows that may occur at a self-service kiosk to obtain simulated transaction data. In some examples, the simulation may include all possibly permutations of transaction or customer flows (e.g., user inputs, screens or interfaces displayed, and the like).

At step 203, simulated transaction data may be captured during the simulation. For instance, data related to a type of transaction, whether the transaction was successful, whether any mechanical issues occurred, a time to complete the transaction, user input received to process the transaction, a number of screens or interfaces displayed during the transaction, and the like may be captured during the simulation.

At step 204, internal entity computing system 120 may connect to anomaly detection computing platform 110. For instance, a first wireless connection may be established between internal entity computing system 120 and anomaly detection computing platform 110. Upon establishing the first wireless connection, a communication session may be initiated between internal entity computing system 120 and anomaly detection computing platform 110.

At step 205, internal entity computing system 120 may transmit or send the simulated transaction data to the anomaly detection computing platform 110. For instance, the simulated transaction data may be transmitted during the communication session initiated upon establishing the first wireless connection.

With reference to FIG. 2B, at step 206, anomaly detection computing platform 110 may receive the simulated transaction data from the internal entity computing system 120.

At step 207, anomaly detection computing platform 110 may build or generate a body of successful customer flows. For instance, anomaly detection computing platform 110 may analyze the received historical data and received simulated transaction data and may identified transactions within the data that were successfully completed (e.g., the requested transaction was processed, the transaction was processed within an expected number of steps, the transaction was processed within an expected amount of time, or the like). For transactions that were successfully completed, customer flows (e.g., processes performed, steps taken, or the like, between initiation of the transaction by the user and completion of the transaction) associated with those transactions may be labeled or identified as successful and may be stored or added to the body of successful customer flows.

In some examples, the body of successful customer flows may be based on the historical data and/or simulated transaction data being used to train a machine learning model to identify anomalies in transactions based on the identified successful customer flows. For instance, the machine learning model may be trained using customer flows identified as successful. The machine learning model may then receive, as inputs, transaction data and, when executed, may output whether an anomaly exists in the transaction data (e.g., the transaction data does not match a customer flow in the body of successful customer flows).

At step 208, a self-service kiosk, such as self-service kiosk 150a, may generate transaction data. For instance, a user may request a transaction via the self-service kiosk 150a and transaction data associated with the transaction (e.g., type of transaction, whether it was completed, time to completion, number of steps, and the like) may be captured by the self-service kiosk.

At step 209, self-service kiosk 150a may connect to anomaly detection computing platform 110. For instance, a second wireless connection may be established between self-service kiosk 150a and anomaly detection computing platform 110. Upon establishing the second wireless connection, a communication session may be initiated between self-service kiosk 150a and anomaly detection computing platform 110.

At step 210, self-service kiosk 150a may transmit or send the transaction data to the anomaly detection computing platform 110. For instance, the transaction data may be sent during the communication session initiated upon establishing the second wireless connection.

With reference to FIG. 2C, at step 211, anomaly detection computing platform 110 may analyze the transaction data to determine whether an anomaly exists in the transaction data. For instance, the transaction data may be compared to the body of successful customer flows to determine whether it matches one or more customer flows. If so, no anomaly may be detected. If not, the transaction data may be flagged as having an anomaly and may be further processed. In some example, machine learning may be used to analyze the transaction data. For instance, the transaction data may be input into a machine learning model and the model may be executed to determine whether an anomaly exists (e.g., whether the transaction data matches one or more successful customer flows). The machine learning model may then output a determination of anomaly or no anomaly. In some examples, the machine learning model output may be a binary output (e.g., yes/no, anomaly/no anomaly, or the like).

At step 212, identified anomalies (or a plurality of identified anomalies) may be compared to one or more thresholds. For instance, transactions flagged as anomalies from a same self-service kiosk 150a may be aggregated and compared to a threshold number of anomalies for a period of time. If the number of anomalies for that self-service kiosk 150a meets or exceeds the threshold for the time period, one or more mitigation actions may be identified and executed.

In another example, one or more transactions flagged as having an anomaly from a particular self-service kiosk 150a may be categories (e.g., a type of anomaly may be identified) and the number of anomalies of any particular type may be compared to a threshold for that type of anomaly. If the threshold is met or exceeded, one or more mitigation actions may be identified and executed.

Various other thresholds may be used without departing from the invention.

At step 213, based on anomaly data meeting or exceeding one or more thresholds and/or, in some examples, a particular type of anomaly being detected, one or more mitigation actions may be identified. Mitigation actions may include causing a self-service kiosk 150a to shut down or power off, causing a self-service kiosk 150a to display a notification to users, causing a self-service kiosk 150a to modify available functionality, or the like.

At step 214, anomaly detection computing platform 110 may generate an instruction or command to execute the identified one or more mitigation actions. At step 215, the anomaly detection computing platform 110 may transmit or send the generated instruction or command to the impacted self-service kiosk 150a.

With reference to FIG. 2D, at step 216, self-service kiosk 150a may receive the mitigation action instruction or command. At step 217, self-service kiosk 150a may execute the received mitigation action instruction or command. For instance, receiving the mitigation action instruction or command may cause the self-service kiosk 150a to automatically execute the instruction or command.

At step 218, based on the executed mitigation action instruction or command, self-service kiosk 150a may modify functionality of the self-service kiosk 150a according to the mitigation action. For instance, the self-service kiosk 150a may power down, display a notification, disable particular functions or options, or the like, based on execution of the mitigation action.

At step 219, self-service kiosk 150a may display a notification indicating that functionality has been modified, that the self-service kiosk 150a is out of order, or the like.

At step 220, anomaly detection computing platform 110 may receive subsequent self-service kiosk data. For instance, anomaly detection computing platform 110 may receive transaction data from one or more self-service kiosks 150a-150c, may receive an indication of execution of one or more mitigation actions, or the like.

With reference to FIG. 2E, at step 221, the machine learning model may be updated and/or validated based on the subsequently received self-service kiosk data. Accordingly, the machine learning model may be tuned and continuously improve in accuracy based on real-world transaction data received from a plurality of self-service kiosks.

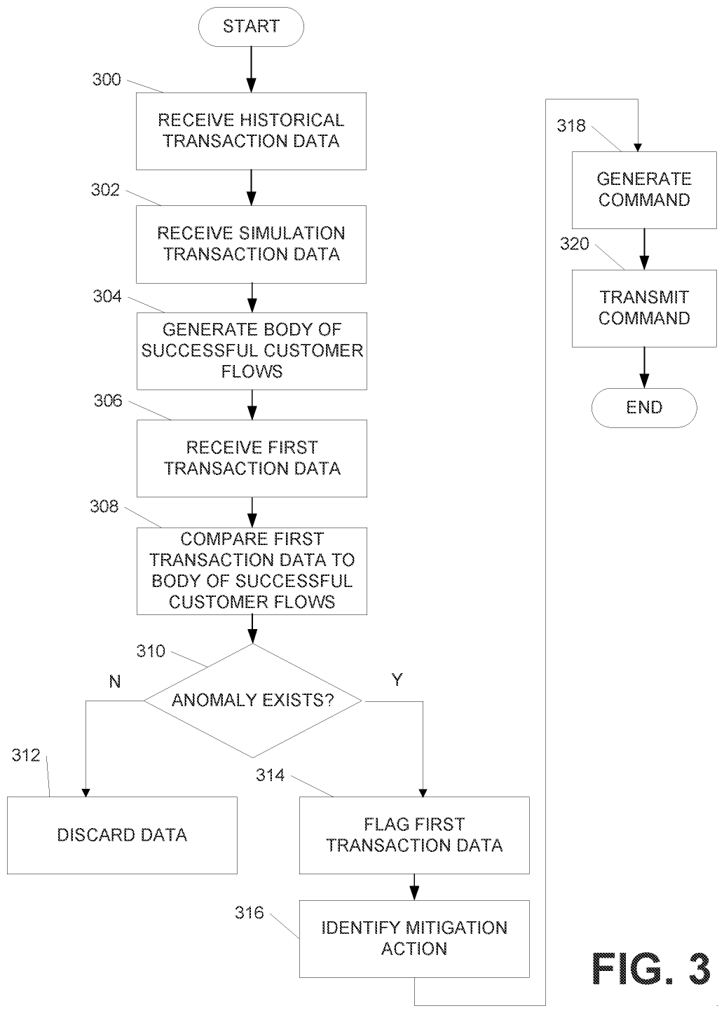

FIG. 3 is a flow chart illustrating one example method of implementing anomaly detection functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, historical transaction data may be received. In some examples, the historical transaction data may include labelled self-service kiosk transaction data indicating steps within the data, whether the transaction was successful completed, or the like.

At step 302, simulation transaction data may be received. For instance, a self-service kiosk simulation may be executed and simulated transaction data may be captured. The simulated transaction data may then be received by the anomaly detection computing platform 110.

At step 304, a body of successful customer flows may be generated. For instance, based on the historical transaction data and the simulated transaction data, a body of successful customer flows (e.g., customer requests for transactions that were successfully completed) may be generated. In some examples, the historical transaction data and simulated transaction data may be used to train a machine learning model to output whether transaction data matches a successful customer flow.

At step 306, first transaction data may be received from a self-service kiosk. In some examples, the first transaction data may include a type of transaction, steps performed, user input received, time to complete the transaction, and the like.

At step 308, the first transaction data may be compared to the body of successful customer flows to determine whether a match exists. In some examples, the machine learning model may receive, as inputs, the first transaction data and, upon execution of the machine learning model, may output whether the first transaction data matches one or more successful customer flow.

At step 310, a determination may be made as to whether an anomaly exists in the first transaction data. For instance, based on the comparison of the first transaction data to the body of successful customer flows, a determination may be made as to whether the first transaction data matches at least one successful customer flow in the body of successful customers flows. If so, a determination may be made that an anomaly does not exists and, at step 312, the first transaction data may be discarded (e.g., deleted).

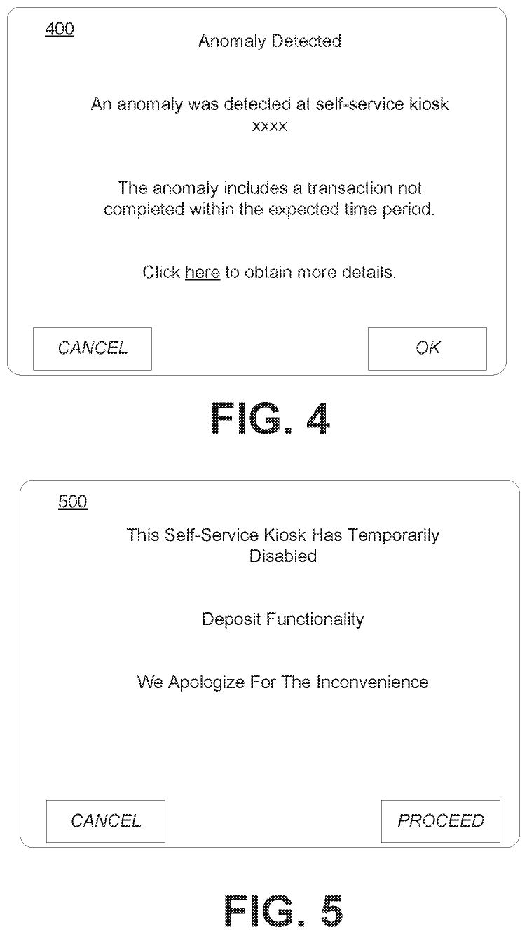

If, at step 310, a match does not exist then a determination may be made that an anomaly does exist in the first transaction data and, at step 314, the first transaction data may be flagged as including an anomaly. In some examples, flagging the transaction data may cause the data to be transmitted to an administrator computing device and displayed on a user interface. For instance, FIG. 4 include one example interface 400 that may be displayed. The interface 400 includes an indication of the self-service kiosk at which the anomaly was detected, a type of anomaly and an interactive link to obtain additional details about the detected anomaly.

With further reference to FIG. 3, at step 316, one or more mitigation actions may be identified. For instance, the identified anomaly and/or the identified anomaly aggregated with one or more other identified anomalies may be compared to one or more thresholds to identify one or more mitigation actions for execution. Mitigation actions may include causing shut down of the self-service kiosk, modifying functionality of the self-service kiosk, causing an interface to display on the self-service kiosk, and the like.

At step 318, based on the identified one or more mitigation actions, an instruction or command causing execution of the one or more mitigation actions may be generated. At step 320, the generated instruction or command may be transmitted or sent to the impacted self-service kiosk. In some examples, transmitting or sending the instruction or command to the impacted self-service kiosk may cause the self-service kiosk to automatically execute the instruction or command, thereby automatically implementing the identified mitigation action.

FIG. 5 illustrates one example interface 500 that may be displayed by a display of a self-service kiosk. The interface 500 includes an indication that particular functionality (e.g., deposits) are not available at this time. In some examples, the deposit functionality of the self-service kiosk may be disabled based on an identified mitigation action and associated command received by the self-service kiosk. The interface 500 may also be automatically displayed based on execution of the mitigation action command. The interface 500 may further include an option for a user to proceed (e.g., if a user would like to proceed with another type of function that is not currently disabled) or an option to cancel any requested transaction.

As discussed herein, aspects described provide dynamic anomaly detection for self-service kiosks. As discussed above, it can be difficult to impossibly to identify many issues or types of issues with self-service kiosks (e.g., slow performance, freezing during transaction, or the like). Arrangements described herein provide for identification of expected outcomes (e.g., successful customer flows) and then identify outcomes other than the expected outcomes (e.g., anomalies) and take mitigating actions based on the anomalies. Accordingly, rather than trying to identify every possible error or issue and then comparing transaction data to the identified issues or errors, arrangements described herein identify successful or expected outcomes and flag anything that does not match those outcomes.

In some examples, each successful customer flow may include a plurality of data points within the flow. In some examples, user transaction data may be compared to each data point to determine whether a match of a successful customer flow exists. In some examples, each data point may match to determine that a match exists. Alternatively, at least a threshold number or percentage of data points may match to determine that a match exists.

For instance, if a successful withdrawal customer flow includes data points such as: 1) user authentication; 2) user selection of withdrawal option; 3) user selection of account from which to withdraw; 4) user selection of amount to withdraw; 5) user confirmation of withdrawal; and 6) dispensing of funds, and all aspects performed within a predetermined amount of time, the data points associated with the user transaction data may be compared to each data point to determine whether a match exists or an anomaly exists.

The example above is merely one example. Various other customer flows, data points, and the like, may be used to identify anomalies without departing from the invention.

Accordingly, the arrangements described herein provide for further analysis of any outcome that is outside an expected outcome. While this may result in analysis of some anomalies that might not require mitigation action, it may greatly reduce the computing resources needed to identify anomalies because systems are not attempting to always identify or match a potential issue. Accordingly, logs may be generated including identified anomalies, kiosk information associated with anomalies, mitigation actions executed, and the like. This may be used to continuously tune the systems.

The arrangements provided herein also provide for identification of anomalies that might not, at the time, be causing disruptions but may, if allowed to continue, cause a device failure or service disruption. Accordingly, logs of anomalies may be analyzed to identify similar types of anomalies and address them when a sufficient number of that type of anomaly (e.g., at least a threshold number) have been detected.

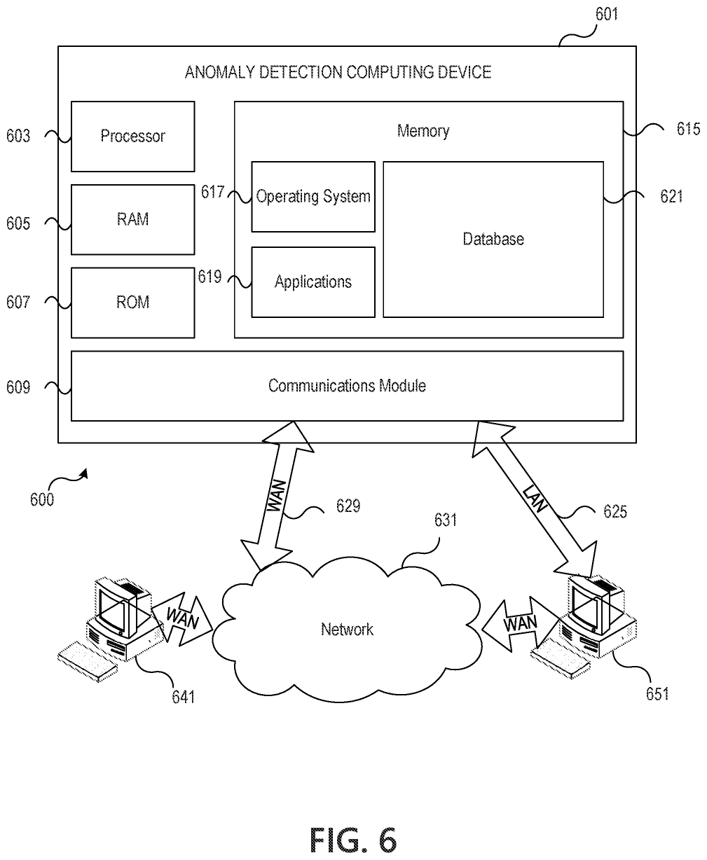

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include anomaly detection computing device 601 having processor 603 for controlling overall operation of anomaly detection computing device 601 and its associated components, including Random Access Memory (RAM) 605, Read-Only Memory (ROM) 607, communications module 609, and memory 615. Anomaly detection computing device 601 may include a variety of computer readable media. Computer readable media may be any available media that may be accessed by anomaly detection computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by anomaly detection computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on anomaly detection computing device 601. Such a processor may execute computer-executable instructions stored on a computer-readable medium.

Software may be stored within memory 615 and/or storage to provide instructions to processor 603 for enabling anomaly detection computing device 601 to perform various functions as discussed herein. For example, memory 615 may store software used by anomaly detection computing device 601, such as operating system 617, application programs 619, and associated database 621. Also, some or all of the computer executable instructions for anomaly detection computing device 601 may be embodied in hardware or firmware. Although not shown, RAM 605 may include one or more applications representing the application data stored in RAM 605 while anomaly detection computing device 601 is on and corresponding software applications (e.g., software tasks) are running on anomaly detection computing device 601.

Communications module 609 may include a microphone, keypad, touch screen, and/or stylus through which a user of anomaly detection computing device 601 may provide input, and may also include one or more of a speaker for providing audio output and a video display device for providing textual, audiovisual and/or graphical output. Computing system environment 600 may also include optical scanners (not shown).

Anomaly detection computing device 601 may operate in a networked environment supporting connections to one or more remote computing devices, such as computing device 641 and 651. Computing devices 641 and 651 may be personal computing devices or servers that include any or all of the elements described above relative to anomaly detection computing device 601.

The network connections depicted in FIG. 6 may include Local Area Network (LAN) 625 and Wide Area Network (WAN) 629, as well as other networks. When used in a LAN networking environment, anomaly detection computing device 601 may be connected to LAN 625 through a network interface or adapter in communications module 609. When used in a WAN networking environment, anomaly detection computing device 601 may include a modem in communications module 609 or other means for establishing communications over WAN 629, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive historical transaction data from a plurality of self-service kiosks;
receive, from a self-service kiosk simulation, simulated transaction data;
generate, based on the historical transaction data and the simulated transaction data, a body of successful customer flows;
receive, from a self-service kiosk of the plurality of self-service kiosks, first transaction data;
compare the first transaction data to the body of successful customer flows to identify whether an anomaly exists in the first transaction data;
responsive to identifying that an anomaly exists:
flag the first transaction data as including an anomaly;
identify at least one mitigation action;
generate a command to execute the at least one mitigation action;
transmit the generated command to the self-service kiosk, wherein transmitting the generated command causes the self-service kiosk to automatically execute the at least one mitigation action, wherein causing the self-service kiosk to automatically execute the at least one mitigation action includes causing the self-service kiosk to modify functionality of the self-service kiosk; and
responsive to identifying that an anomaly does not exist, discarding the first transaction data.

2. The computing platform of claim 1, wherein a successful customer flow includes steps performed between initiation of a transaction by a user and successful completion of the transaction by the user.

3. The computing platform of claim 1, wherein comparing the first transaction data to the body of successful customer flows to identify whether an anomaly exists in the first transaction data includes executing a machine learning model.

4. The computing platform of claim 1, further including instructions that, when executed, cause the computing platform to:
responsive to identifying that an anomaly exists, comparing at least the identified anomaly in the first transaction data to one or more mitigation action thresholds;
responsive to determining that the at least the identified anomaly in the first transaction data meets or exceeds the one or more mitigation action thresholds, identifying the at least one mitigation action; and
responsive to determining that the at least the identified anomaly in the first transaction data is below the one or more mitigation action thresholds, storing the first transaction data.

5. The computing platform of claim 4, wherein the one or more mitigation action thresholds are based on a type of anomaly detected.

6. The computing platform of claim 1, wherein modifying functionality of the self-service kiosk includes at least one of: powering down the self-service kiosk, disabling one or more functions of the self-service kiosk, and causing a notification to display on a display of the self-service kiosk.

7. The computing platform of claim 1, wherein the self-service kiosk simulation including simulating a plurality of user transactions and capturing transaction data associated with each simulated user transaction of the plurality of simulated user transactions.

8. A method, comprising:
receiving, by a computing platform, the computing platform having at least one processor and memory, historical transaction data from a plurality of self-service kiosks;
receiving, by the at least one processor and from a self-service kiosk simulation, simulated transaction data;
generating, by the at least one processor and based on the historical transaction data and the simulated transaction data, a body of successful customer flows;
receiving, by the at least one processor and from a self-service kiosk of the plurality of self-service kiosks, first transaction data;
comparing, by the at least one processor, the first transaction data to the body of successful customer flows to identify whether an anomaly exists in the first transaction data;
when it is determined that an anomaly exists:
flagging, by the at least one processor, the first transaction data as including an anomaly;
identifying, by the at least one processor, at least one mitigation action;
generating, by the at least one processor, a command to execute the at least one mitigation action;
transmitting, by the at least one processor, the generated command to the self-service kiosk, wherein transmitting the generated command causes the self-service kiosk to automatically execute the at least one mitigation action, wherein causing the self-service kiosk to automatically execute the at least one mitigation action includes causing the self-service kiosk to modify functionality of the self-service kiosk; and
when it is determined that an anomaly does not exist, discarding the first transaction data.

9. The method of claim 8, wherein a successful customer flow includes steps performed between initiation of a transaction by a user and successful completion of the transaction by the user.

10. The method of claim 8, wherein comparing the first transaction data to the body of successful customer flows to identify whether an anomaly exists in the first transaction data includes executing a machine learning model.

11. The method of claim 8, further including:
when it is determined that an anomaly exists, comparing, by the at least one processor, at least the identified anomaly in the first transaction data to one or more mitigation action thresholds;
when it is determined that the at least the identified anomaly in the first transaction data meets or exceeds the one or more mitigation action thresholds, identifying the at least one mitigation action; and
when it is determined that the at least the identified anomaly in the first transaction data is below the one or more mitigation action thresholds, storing the first transaction data.

12. The method of claim 11, wherein the one or more mitigation action thresholds are based on a type of anomaly detected.

13. The method of claim 8, wherein modifying functionality of the self-service kiosk includes at least one of: powering down the self-service kiosk, disabling one or more functions of the self-service kiosk, and causing a notification to display on a display of the self-service kiosk.

14. The method of claim 8, wherein the self-service kiosk simulation including simulating a plurality of user transactions and capturing transaction data associated with each simulated user transaction of the plurality of simulated user transactions.

15. One or more non-transitory computer-readable media storing instructions that, when executed by a computing platform comprising at least one processor, memory, and a communication interface, cause the computing platform to:
receive historical transaction data from a plurality of self-service kiosks;
receive, from a self-service kiosk simulation, simulated transaction data;
generate, based on the historical transaction data and the simulated transaction data, a body of successful customer flows;
receive, from a self-service kiosk of the plurality of self-service kiosks, first transaction data;
compare the first transaction data to the body of successful customer flows to identify whether an anomaly exists in the first transaction data;
responsive to identifying that an anomaly exists:
flag the first transaction data as including an anomaly;
identify at least one mitigation action;
generate a command to execute the at least one mitigation action;
transmit the generated command to the self-service kiosk, wherein transmitting the generated command causes the self-service kiosk to automatically execute the at least one mitigation action, wherein causing the self-service kiosk to automatically execute the at least one mitigation action includes causing the self-service kiosk to modify functionality of the self-service kiosk; and
responsive to identifying that an anomaly does not exist, discarding the first transaction data.

16. The one or more non-transitory computer-readable media of claim 15, wherein a successful customer flow includes steps performed between initiation of a transaction by a user and successful completion of the transaction by the user.

17. The one or more non-transitory computer-readable media of claim 15, wherein comparing the first transaction data to the body of successful customer flows to identify whether an anomaly exists in the first transaction data includes executing a machine learning model.

18. The one or more non-transitory computer-readable media of claim 15, further including instructions that, when executed, cause the computing platform to:
responsive to identifying that an anomaly exists, comparing at least the identified anomaly in the first transaction data to one or more mitigation action thresholds;
responsive to determining that the at least the identified anomaly in the first transaction data meets or exceeds the one or more mitigation action thresholds, identifying the at least one mitigation action; and
responsive to determining that the at least the identified anomaly in the first transaction data is below the one or more mitigation action thresholds, storing the first transaction data.

19. The one or more non-transitory computer-readable media of claim 18, wherein the one or more mitigation action thresholds are based on a type of anomaly detected.

20. The one or more non-transitory computer-readable media of claim 15, wherein modifying functionality of the self-service kiosk includes at least one of: powering down the self-service kiosk, disabling one or more functions of the self-service kiosk, and causing a notification to display on a display of the self-service kiosk.

21. The one or more non-transitory computer-readable media of claim 15, wherein the self-service kiosk simulation including simulating a plurality of user transactions and capturing transaction data associated with each simulated user transaction of the plurality of simulated user transactions.
